(19) United States
(12) Patent Application Publication
(10) Pub. No.: US 2003/0198281 A1
(43) Pub. Date: Oct. 23, 2003

(54) Wireless communications system

(76) Inventors: Ian Grier, Montreal (CA); Allan Klein, Lachine (CA)

Correspondence Address: GOWLING LAFLEUR HENDERSON, Suite 2600, 160 Elgin Street, Ottawa, ON, KIP 1C3, CA

(21) Appl. No.: 10/123,419

(22) Filed: Apr. 17, 2002

(51) Int. Cl. H04B 1/713

(52) U.S. Cl. 375/133

(57) ABSTRACT

A wireless communications system is described for subscribers scattered at distances of up to 40 km. Wireless access for subscribers is provided from wireless base-stations (WBS) that are connected to a PSTN access node 16 via T1 links. These links support the subscriber traffic, and also provide network management. Where, due to terrain, the whole area can not be served from a single WBS site, additional WBS may have to be installed to provide fill-in coverage. However, all WBS in the coverage area are connected to the same PSTN access node. A wireless loop air interface structure consists of 2304 bits per 4 milliseconds divided into an outbound portion and an inbound portion with a gap of 48 bits between. The communications air interface uses a Frequency Hopping Spread-Spectrum (FHSS) air interface as specified for the 2.4-2.4835 GHz ISM band. The FCC regulations for occupied channel avoidance FH are given in 47CFR2.47(h). The intelligent adaptation of the FH code used by each WBSR follows this regulation. This is done by making each WBSR individually select and/or adapt its hop set, based on its detection of potentially interfering signals.

### FIELD OF THE INVENTION

The present invention relates to wireless communications systems and is particularly concerned with providing telephone local loop communications.

### BACKGROUND OF THE INVENTION

Analog and digital cellular telephones are well known for providing both voice and data communications services to end-users. The widespread use of such devices makes them familiar tools of communication for urban and suburban subscribers. Ironically the same subscribers are also serviced by conventional telephone lines that now offer high-speed data services in addition to plain old telephone service (POTS) and cable television. In many countries, including the United States and Canada, rural areas remain under serviced when it comes to advanced telephony or data services. Technology well suited for urban and suburban deployment remains too costly to use for sparsely populated areas involving large distances between subscribers.

### SUMMARY OF THE INVENTION

An object of the present invention is to provide an improved fixed wireless communications system.

Accordingly the present invention provides a wireless communication system suitable for wireless local loop applications in rural areas.

In accordance with an aspect of the present invention there is provided a wireless communications system comprising: a base station having a first base station radio for frequency hopping transmission and including a first frequency sequence selector for selecting a first predetermined sequence of frequencies; and a second base station radio for frequency hopping transmission and including a second frequency sequence selector for independently selecting a second predetermined sequence of frequencies different from the first.

In accordance with an aspect of the present invention there is provided a method of operating a wireless communications system comprising the steps of: at a base station, selecting a first predetermined sequence of frequencies for frequency hopping transmission by a first base station radio; and independently selecting a second predetermined sequence of frequencies different from the first for frequency hopping transmission by a second base station radio.

### BRIEF DESCRIPTION OF THE DRAWINGS

The present invention will be further understood from the following detailed description of an embodiment with reference to the drawings in which:

FIG. 1 illustrates, in a block diagram, a communications system in accordance with an embodiment of the present invention;

FIGS. 2a and 2b illustrate a wireless loop air interface structure and a burst structure for the communications system of FIG. 1;

FIG. 3 illustrates, in a block diagram, a wireless base station for the communications system of FIG. 1;

FIG. 4 illustrates, in a block diagram, a wireless base station radio for the wireless base station of FIG. 3;

FIG. 5 illustrates a state-action diagram of an intelligent interference avoidance algorithm for the base station radio of FIG. 4; and

FIG. 6 illustrates in a block diagram, a wireless terminal for the communications system of FIG. 1.

### DETAILED DESCRIPTION OF THE PREFERRED EMBODIMENT

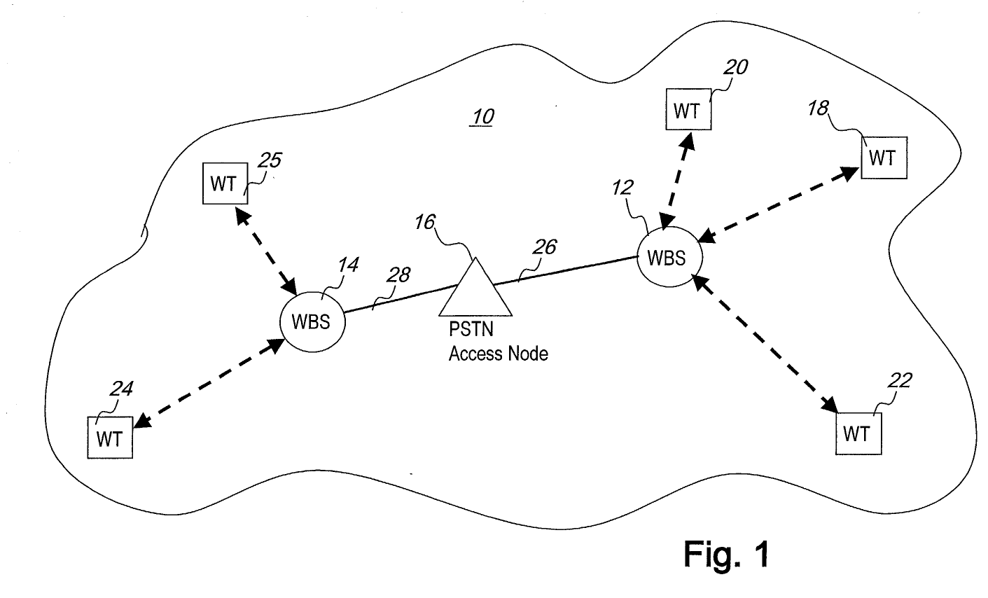

Referring to FIG. 1, there is illustrated in a block diagram a communication system in accordance with an embodiment of the present invention. A communications system provides wireless coverage area 10. The system includes wireless base station (WBS) 12 communicating with wireless terminals (WT) 18, 20 and 22 and WBS 14 communicating with WT 24 and WT25. The WBS 12 and 14 are connected to a public switched telephone network (PSTN) access node 16 via multiple T1 links 26 and 28, respectively.

The system architecture is shown in FIG. 1. Subscribers to be served by the communications system may be scattered at distances of up to 40 km. Wireless Access for subscribers is provided from Wireless Base-stations (WBS) 12 and 14, which will be connected back to the PSTN Access Node 16 via T1 links 26 and 28. These links 26 and 28 support the subscriber traffic, and also provide Network Management. A remote switch or RT (not shown in FIG. 1) provides the network reference clock via the T1 links to each WBS.

Where, due to terrain, the whole area can not be served from a single WBS site, additional WBS may have to be installed to provide fill-in coverage. However, all WBS in the coverage area are connected to the same PSTN access node 16.

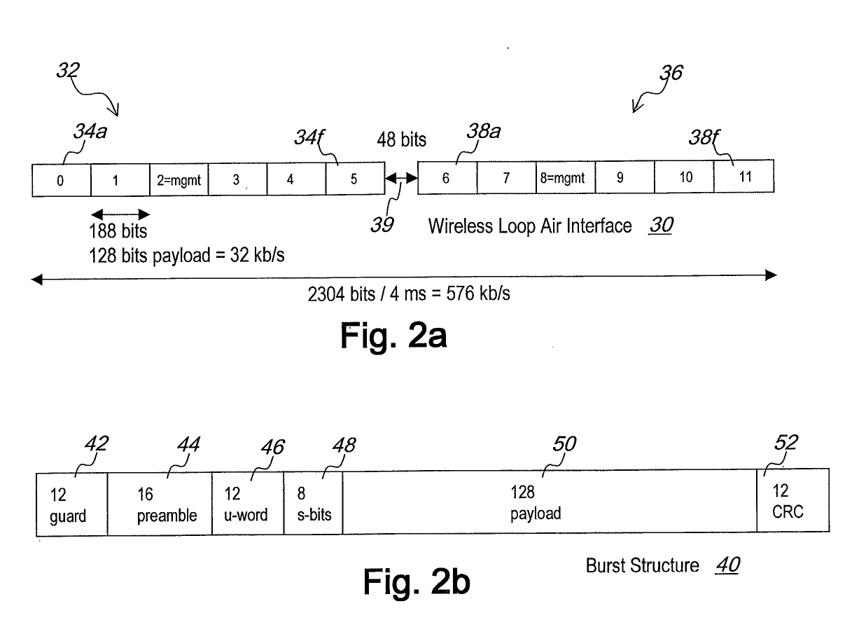

Referring to FIG. 2a, there is illustrated a wireless loop air interface structure in accordance with an embodiment of the present invention. The air interface 30 consists of 2304 bits per 4 milliseconds divided into an outbound portion 32 having airbound timeslots 34a-f and an inbound portion 36 having inbound timeslots 38a-f. There is a gap of 48 bits between the outbound portion 32 and the inbound portion 34 forming a guard space 39. The communications air interface uses a Frequency Hopping Spread-Spectrum (FHSS) air interface as specified for the 2.4-2.4835 GHz ISM band.

Referring to FIG. 2b, there is illustrated a burst structure in accordance with an embodiment of the present invention. The burst structure 40 for each time slot of 188 bits includes a 128 bit payload. The burst structure 40 includes a 12-bit guard 42, a 16-bit preamble 44, a 12-bit unique-word 46, a 8-bit signaling-bits 48, a 128-bit payload 50 and a 12-bit CRC 52.

Time Division Duplexing (TDD) is used to support full duplex communications. Time Division Multiple Access is used to allow several communications links to be supported by a single RF carrier. The TDD frame is shown in FIG. 2a. At a system level it is a symmetric TDD air interface. Referenced to the WBS, there are 6 outbound (WBS transmit) timeslots 34 followed by a guard space 39 and 6 inbound (WBS receive) timeslots 38.

With respect to an individual WT the Outbound P-MP WBSR transmitter may be bursting on all 6 timeslots during periods of high traffic, but an individual P-P WT transmitter typically bursts in only one timeslot when busy, but when polled will transmit during the management timeslot as well. The TDD frame length is 4 ms.

Both the Outbound P-MP transmitter and the Inbound P-P transmitters use Gaussian minimum shift keying modulation (GMSK), with a BT product of 0.5. B is the pre-modulation filter BW and T is the bit period. The raw data rate is 576 kb/s. Frequency hopping is implemented by transmitting each frame at a different frequency, following a pseudo-random sequence.

Wireless Terminals operating beyond 8.5 km are denied use of the last timeslot pair for traffic, in order to use timeslot 5 to extend the guard space from 48 bits to 236 bits (48+188). The increased guard space accommodates the additional transmission delay on paths between 8.5 and 40 km.

The air interface MAC layer provides full duplex circuit switched connectivity between the WT and WBS to support the POTS applications.

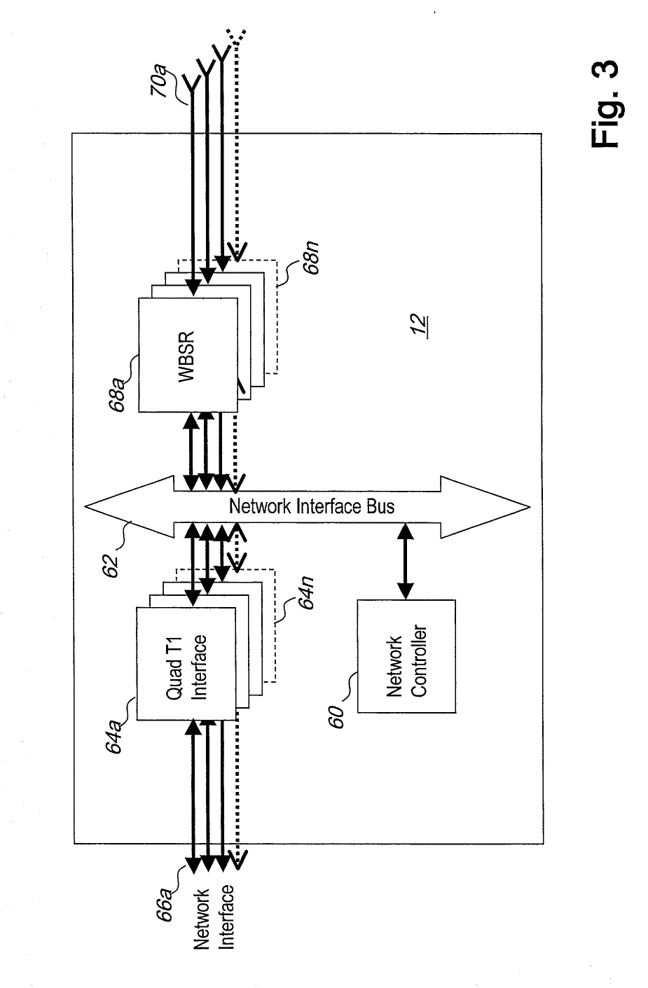

Referring to FIG. 3, there is illustrated in a block diagram a wireless base station in accordance with an embodiment of the present invention. The wireless base station (WBS) 12 includes a network controller 60, a network interface bus 62, a plurality of quad T1 interfaces 64a-64n, each coupled to a network interface 66a-66n, respectively. The network controller 60 and Quad T1 interfaces 64a-h communicate through the network interface bus 62. The WBS 12 also includes a plurality of wireless base station radios (WBSR) 68a-68h coupled to antennae 70a-70n.

At each WBS-site 12, several WBS radios (WBSRs) 68a-n may be co-located—up to 20 maximum. The quantity provisioned depends upon the number of telephone lines required and the traffic load. The traffic load will be primarily dependant upon the number of subscribers using the facility for voice and Internet connections.

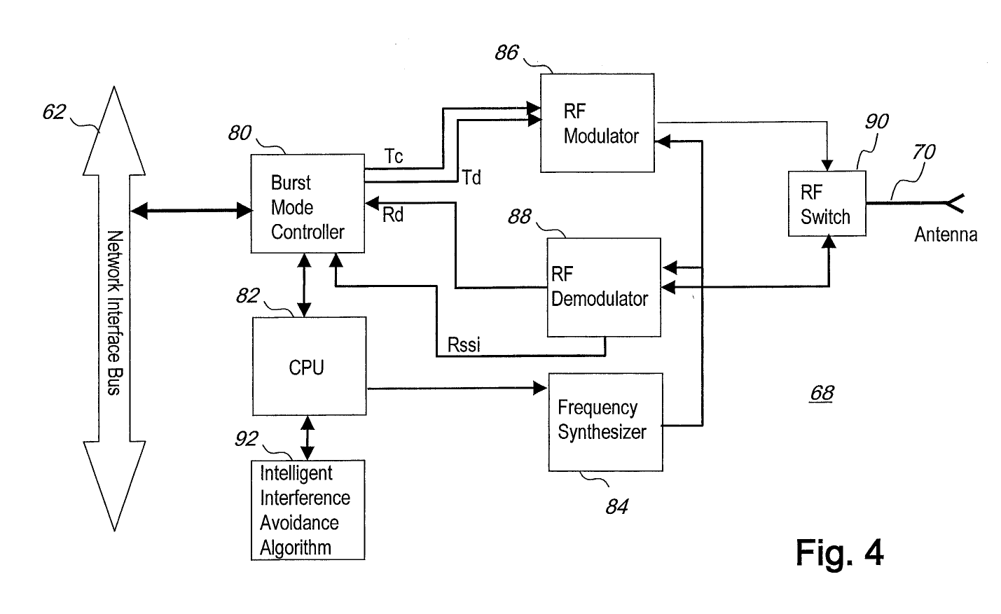

Referring to FIG. 4 there is illustrated in a block diagram a wireless base station radio (WBSR) 68. The WBSR 68 includes a burst mode controller 80, a CPU 82, a frequency synthesizer 84, an RF modulator 86, an RF demodulator 88, an RF switch 90 and an intelligent interference avoidance algorithm 92. The burst mode controller 80 is coupled to the network interface bus 62. The RF switch is coupled to the antenna 70. The CPU is coupled to the intelligent interference avoidance algorithm 92.

Duplex Communications System:

In order to provide full duplex communications, two radio systems are used, Outbound and Inbound.

Outbound Transmission System

At the WBS a transmitter is used to send management information, call set up commands, and data in the outbound direction (switch to subscriber) to a receiver located at the subscribers premises. A single WBS transmitter can transmit traffic to the outbound receivers of multiple Wireless Terminals (WTs) simultaneously. Also, in order to provide sufficient capacity to serve the subscribers within its coverage range, each WBS site may house several Outbound transmitters.

As the WTs are not co-located the Outbound Transmission System is a Point-Multipoint (P-MP) system, with the transmitter located at the WBS. This system can use an omni-directional or directional (i.e. sector) antenna to transmit to the WTs in its service area.

Inbound Transmission System

The Inbound transmission system sends requests for service and data from the Wireless Terminal (WT) located at the subscribers premises to the single WBS location. This location is essentially an extension of the local exchange, and connects to the unique line number for that subscriber. WTs are therefore not allowed to transmit data to any other WBS directly or to any other WT.

The Inbound Transmission system is therefore a Point-Point (P-P) system with the transmitter located at the WT. This system will use a directional antenna to transmit to the WBS.

In order to support full duplex phone or modem traffic, connections must be set up simultaneously on each transmission system.

Equipment Configuration:

In order to minimize the hardware equipment cost, the Inbound transmitter and Outbound receiver at the WT may be housed in the same equipment package. The transmitter and receiver may also share the same antenna.

A similar configuration will be used at the WBS, where the Outbound transmitter and Inbound receiver will be co-located on a single plug-in assembly, the Wireless Base-Station Radio (WBSR). The WBS will be capable of housing multiple WBSRs, in order to increase the number of subscribers that may be served in an area. Each WBSR may use its own antenna system, or share a single antenna with the other co-located WBSR, via a combining network.

Each WBS is configured and maintained by the Network Management System (NMS). A single NMS server is capable of managing multiple WBS, and can therefore be used to administer a number of separate service areas from a single location.

Hop Rate:

Each frame has a duration of 4 ms. And is transmitted at a different frequency. The hop rate is therefore 250 hops per second.

Channel Plan:

The 20 dB bandwidth of the communications hopping channel is 1 MHz. This is equal to the maximum BW limit as specified in 46CFR15.247(a)(1)(ii). The receiver input bandwidth is the same as the transmitter hopping frequency bandwidth. This maximizes adjacent channel rejection, preventing adjacent channel transmissions from generating interference at the WT and at the WBSR.

A 1 MHz channel spacing allows the use of 80 channels within the 2400-2483.5 MHz band. The channel plan is shown as follows (frequencies are channel center):

Channel 1: 2402.000 MHz

Channel 2: 2403.000 MHz

Channel 3: 2404.000 MHz

. . .

Channel 80: 2481.000 MHz

The center frequency of a channel n is given by:

Fc(n)=2402+(n−1) MHz,

Where n is an integer in the range of 1 to 80

Spurious Emissions:

This channel plan provides a guard space of 1.5 MHz at the lower band edge, and 2 MHz at the upper band edge. This guard space will be sufficient to comply with the out of band spurious emission level limit of −20 dBc (100 kHz measurement bandwidth).

Spurious Emissions Limits are Defined as Follows (47CFR15.249 and 15.205):

Within the band 2400-2483.5 MHz, 50 mV/m at 3 m, in 1 MHz bandwidth, average power detector.

Outside the band (including harmonics and sub-harmonics), 500 uV/m at 3 m (−50 dBc)

WBSR Antenna:

The gain of the WBS antenna will be matched to the power into the antenna so as to limit the maximum EIRP of a WBSR to +36 dBm. Typically the WBS antenna will normally be an omni-directional type with a gain of 10 dBi to provide the required coverage.

Where the population distribution and traffic demand warrants it, however, it will be efficient to use sectoral antennas fed via an antenna-coupling network. The network is needed to combine the output of several WBSR radios, and/or permit several sectoral antennas to be used. Regardless of the antenna gain used, the power into the antenna will be adjusted such that the EIRP limit of 36 dBm is never exceeded.

The WBSR, coupler network, antennas and transmission line shall be configured as a package to ensure that the correct antennas are provided with each type of coupler, in order to ensure that the FCC EIRP limit is always met. To this end for each specific application package the maximum WBSR transmit power will be factory set. Labeling on the WBSR transmitters will be used to permanently identify the system configuration.

Automatic Power Control (APC):

APC is required to reduce adjacent channel interference between signals received at co-located WBSR. Without APC, weak signals from a far WT received at WBSR “A” could be degraded by strong adjacent channel signals transmitted to a co-located WBSR “B” from a nearby WT. The link from a WT to a WBSR is always a point-to-point link, operating in a near line-of sight condition, with low obstruction losses. Over the range of 40 km to 1 km, the variation in LOS path loss on these links will therefore be approximately 32 dB. APC reduces the EIRP emission from near WT, i.e. the closer the WT to the WBSR, the lower the WT transmit power.

For the FH radio, the APC algorithm will decrease the WT output power as required so that the WBSR receive signal level is adjusted to fall within a 10 dB window (−65 to −75 dBm). WTs located at the maximum range of 40 km will have a received signal level at the WBSR of approx. −75 dBm. WTs at this range will be operating close to the WT EIRP limit.

APC reduces interference caused by differences in distance. Also it will provide some help for shorter links experiencing slow, shallow fading activity.

APC Dynamic Range:

The system is required to operate over a range from 1 km to 40 km without any special installation procedures. At 1 km, the path loss is 100 dB, and the maximum receive signal level (RSL) at the WT will be −40 dBm as APC is not active over the outbound point-to-multipoint links. Without APC the maximum signal level received at a WBSR from a WT over a 1 km link will also be −40 dBm, but −75 dBm from a WT at a distance of 40 km. In order to control adjacent channel interference the APC range must be sufficient to reduce the RSL for the 1 km path to at least −65 dBm. The minimum APC range required is then 25 dB.

Hop Sequences:

The communications Air Interface uses 80 discrete channels. Frequency hopping is performed in a pseudo-random fashion, with the hops uniformly distributed among the available channels within a 40-second period. A short PN sequence is used, that repeats after 80 hops, or 320 ms. Each frequency will therefore be used 125 times in 40 seconds (or approximately 93 times over a 30-second period.) The set of available hop sequences is programmed into each WBSR and WT within the coverage area. The short sequence serves two purposes:

1) Because each frequency is used only once in the sequence, the WT can more easily locate the position of the WBSR on the sequence, after scanning for a minimal number of frames.

2) For the same reason, each WBSR can adopt its hop set with respect to other potential interference sources by detecting their transmissions and then intelligently adjusting its hopping sequence to minimize the interference.

A hop sequence is comprised of 80 frequencies that are pseudo-randomly distributed, with the constraint that each hop is at least 4 MHz away from the previous hop. This is to reduce the probability of hopping into a deep fade on two consecutive hops.

Twenty different hop sequences are available for selection to allow each transmitter some flexibility in avoiding interference—even in the presence of multiple uncoordinated co-located transmitters. Each of the twenty sequences is a pre-defined pseudo-random sequence. The following sequences are examples of possible hop sequences (the numbers listed refer to the channel numbers defined in Channel Plan, section 3.4.2.)

Hop Sequence #1:

{2,25, 64, 10,45,18,73,49,21,63,78,31,61,24,54,65,28,79,33,4,20,13,38,74,56,71,23,5, 39,12,36,68,9,70,77,6,62,29,14,1,27,16,59,43,76,34,72,11,60,80,47,22,75,66,41,15,35 67,52,58,44,50,17,7,19,8,69,51,42,3,30,57,37,55,26,46,53,40,32,48}

Hop Sequence #2:

{6,29,68,14,49,22,77,53,25,67,2,35,65,28,58,69,32,3,37,8,24,17,42,78,60,75,27,9,43, 16,40,72,13,74,1,10,66,33,18,5,31,20,63,47,80,38,76,15,64,4,51,26,79,70,45,19,39,71 56,62,48,54,21,11,23,12,73,55,46,7,34,61,41,59,30,50,57,44,36,52}

Hop Sequence #3:

{10,33,72,18,53,26,1,57,29,71,6,39,69,32,62,73,38,7,41,12,28,21,46,2,64,79,31,13,47 20,44,76,17,78,5,14,70,37,22,9,35,24,67,51,4,42,80,19,68,8,55,30,3,74,49,23,43,75, 60,66,52,58,25,15,27,16,77,59,50,11,38,65,45,63,34,54,61,48,40,56}

Hop Sequence #4:

{14,37,76,22,57,30,5,61,33,75,10,43,73,36,66,77,42,11,45,16,32,25,50,6,68,3,35,17, 51,24,48,80,21,2,9,18,74,41,26,13,39,28,71,55,8,46,4,23,72,12,59,34,7,78,53,27,47, 79,64,70,56,62,29,19,31,20,1,63,54,15,42,69,49,67,38,58,65,52,44,60}

Intelligent Interference Avoidance:

Each WBSR transmitter obtains the 4 ms TDD frame timing from the 160 ms WBS frame marker transmitted over the WBS cabinet back-plane. This signal prevents the WBSR from transmitting with the Inbound and Outbound half-frames overlapped, ensuring that the P-M-P and P-P Systems are fully isolated.

The FCC regulations for occupied channel avoidance FH [47CFR2.47(h)] specifies:

The incorporation of intelligence within a frequency hopping spread spectrum system that permits the system to recognize other users within the spectrum band so that it individually and independently chooses and adapts its hop sets to avoid hopping on occupied channels is permitted. The coordination of frequency hopping systems in any other manner for the express purpose of avoiding the simultaneous occupancy of individual hopping frequencies by multiple transmitters is not permitted.

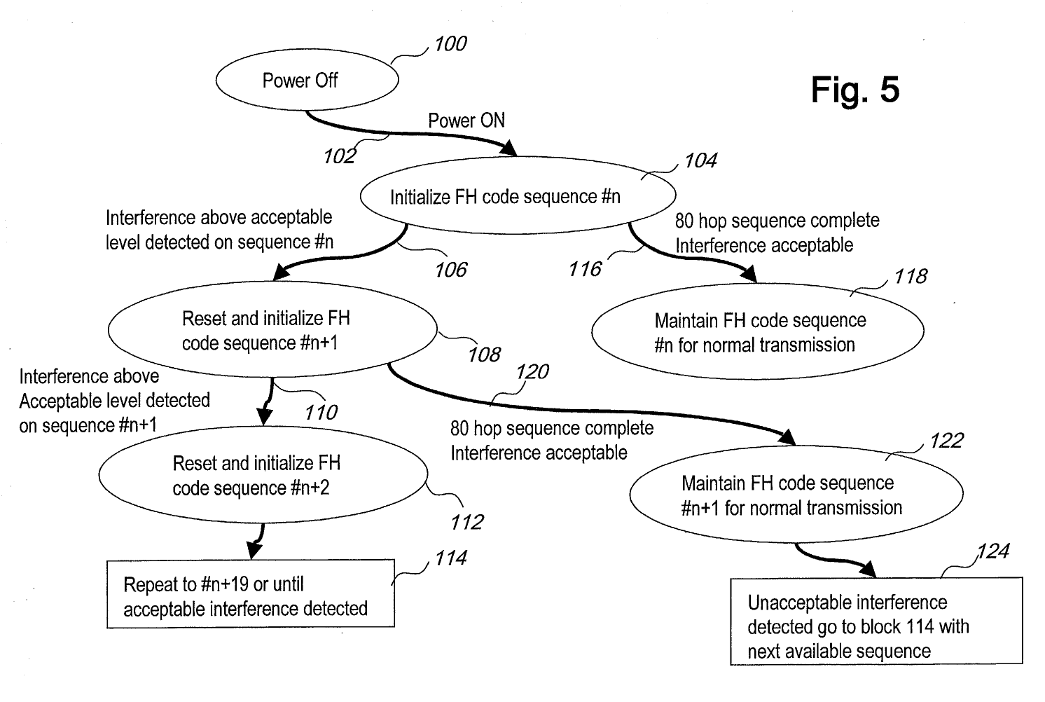

Referring to FIG. 5, there is illustrated a state-action diagram of the intelligent interference avoidance algorithm of the wireless base station radio of FIG. 4. The WBSR 68 is initially in a powered down state as represented by an ellipse 100. On powering up the WBSR 68, as indicated by an arrow 102, an action “Initialize FH code sequence #n” is taken as represented by an ellipse 104. If interference is detected above an acceptable level on sequence #n, as indicated by an arrow 106, an action “Reset and initialize FH code sequence, #n+1 is taken as represented by an ellipse 108. If unacceptable interference is again detected as indicated by an arrow 110, an action “Reset and initialize FH code sequence #n+2” is taken as represented by an ellipse 112. This process is repeated for each code sequence through to #n+19 until no unacceptable interference is detected as represented by a block 114. If the first attempted code sequence #n is successful as indicated by an arrow 116, the #n sequence is maintained for normal transmission and represented by an ellipse 118. If the second attempted code sequence is successful as indicated by an arrow 120, the #n+1 sequence is maintained for normal transmission as indicated by an ellipse 122. These steps are sequentially applied until all the WBSR 68a-n of WBS 12 are operational. The intelligent interference avoidance algorithm (IIAA) relies on the CPU 82 to monitor performance during normal operations. If performance falls below accepted levels the IIAA is initiated for the affected WBSR 68 as represented by a block 124.

The intelligent adaptation of the FH code used by each WBSR follows the above regulation. This is done by making each WBSR individually select and/or adapt its hop set, based on its detection of potentially interfering signals. More details are provided in the next section.

WBSR Transmitter Hop Sequence Selection:

On power-up, each base station transceiver independently searches for foreign signal sources using an “intelligent interference detection” circuit. The purpose is to detect the presence of interference such as intentional radiators, other spread spectrum transmitters or microwave oven radiation. After scanning for a fixed observation time, the base station transceiver will independently select one of the predefined hopping sequences with the objective of minimizing the interference effect of any other detected signal sources. This process may also be repeated in situations where severe link degradation is detected during normal system operation.

After a hopping sequence has been selected, the transmitter tunes itself to a prescribed channel within the sequence. The transmitter remains on that channel for 2 ms, waits 2 ms and then “hops” to a second pre-selected channel. The transmitter remains on that channel for 2 ms and then hops to the third pre-selected channel. The transmitter continues hopping in a pseudo-random sequence until all channels have been used. Once all channels have been used, the transmitter repeats the pseudo-random sequence. This hopping sequence is followed even in situations when the transmitter output is not enabled (when there is no data to be sent) so that the sequence always repeats after 80 hops (or 320 ms), regardless of the amount of data transmitted. This sequence is repeated as long as the transmitter is powered-up. Whenever there is data to be sent, it is transmitted at the current channel within the hopping sequence and so it does NOT start from the same point each time.

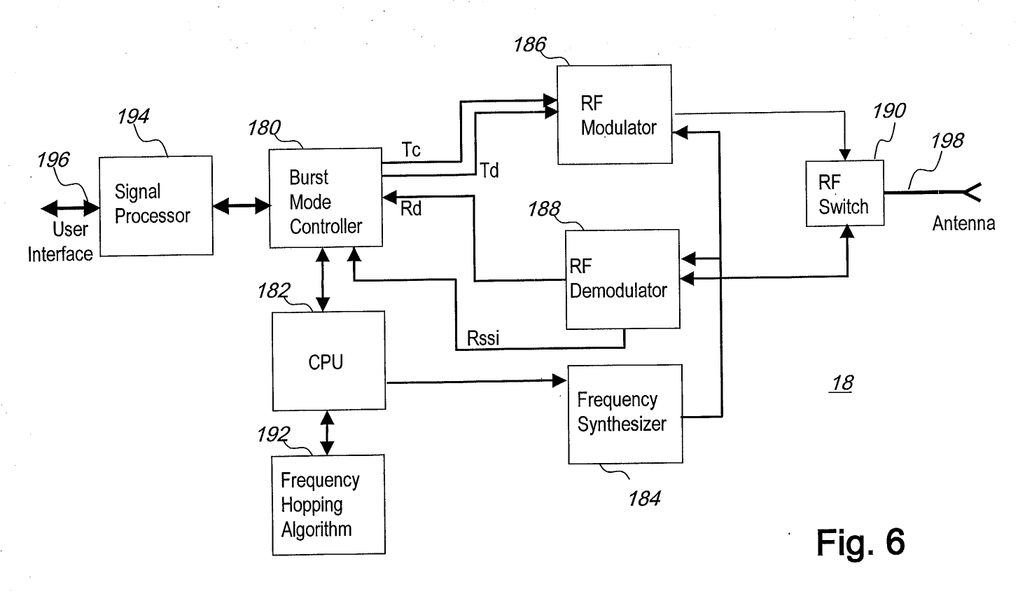

Referring to FIG. 6, there is illustrated in a block diagram a wireless terminal (WT) 18. The WT18 includes a burst mode controller 180, a CPU 182, a frequency synthesizer 184, an RF modulator 186, an RF demodulator 188 an RF switch 190, a frequency hopping algorithm 192, and a signal processor 194 coupled to a user interface 196. The RF switch 190 is connected to an antenna 198.

WT Antenna:

The WT is a P-P transmitter, as it can only communicate with a single WBS site. Since FCC rules state that it is required to reduce peak transmit output power by 1 dB for every 3 dB that the antenna gain is raised, an increase in EIRP of 2 dB is realized for every 3 dB that the antenna gain is raised (see 47CFR15.247(b)(3)(i)). It therefore makes sense to use a high gain, narrow beam antenna at the WT to optimize the Inbound P-P radio link.

The system design is based on a high gain parabolic grid antenna, which is available at moderate cost and size. Because there will be almost no subscribers at close range, this antenna configuration shall be used at all WT sites. Further, the WT shall be designated to prohibit the connection of higher gain antennas.

The antenna shall be equipped with an integral feed cable. The target net antenna gain (including feed loss) is 24 dBi. Then the maximum WT transmit power into the antenna (intentional radiator) must be factory set so as not to exceed 24 dBm (30 dBm-(24-6)/3 dB).

With Automatic Power Control the actual WT transmit power may be as much as 25 dB lower (see below).

WT FH Code Acquisition:

FH code acquisition will only be needed on initialization of a WT receiver on startup, or after a failure, such as a power outage.

Inbound Frame Adaptation (Autotiming):

Once frame adaptation has been achieved, the WT then adjusts, or auto-times its Rx-Tx time offset so that the Inbound WT transmitter signal to the WBSR arrives aligned with the WBSR receiver frame (Inbound frame and hop adaptation). The auto-timing process requires a handshake between WT and WBSR over a small subset of management timeslots, and typically takes <30 seconds.

WT Authentication and Registration:

Each WT in the coverage area will be programmed with a unique WT ID. Each WBS will only allow authorized WTs to register. The valid WT Ids are entered via the Insight NMS. Only WTs that have completed the registration process are allowed access to traffic time-slots.

Coverage Planning:

An ID that uniquely identifies each WBSR will prevent WTs from attempting to register with a remote WBS provisioned to provide fill-in coverage. However, to control interference degradation, the signal levels from such distant WBS sites should be limited to a level of 20 dB or more below that of the WT receiver threshold.

Although the directional antenna used at the WTs will help control interference from an unwanted WBS, for some WTs, the antenna may be aligned with the azimuth of both the desired WBS site and a remote WBS site. In this case the physical separation of the WBS sites will provide the isolation required for an acceptable signal/interference ratio.

The use of a short PN sequence allows a simple acquisition algorithm to be used by the WT. Upon start-up the WT receiver waits at a start frequency until its Burst Management Control (BMC) correlator detects a management burst (unique word). The WT can then start hopping on one of the hop sequences with its transmitter disabled. After a number of consecutive WBSR transmissions are successfully received, the WT can declare a preliminary code alignment. If preliminary code alignment is not found on the particular hop sequence tried, the same process is repeated for another of the defined hop sequences until FH code alignment is obtained.

Synchronization is achieved when the receiver follows the same hopping sequence as the WBSR transmitter, tuning itself to a new channel on each 4 ms boundary. The transmitter and receiver are always operating on the same frequency during any 4 ms period, regardless of whether there is any data destined for the receiver. When a packet transmission is repeated or when multiple packets are sent, the transmitter simply uses the next frequency in its sequence to transmit. Since the receiver's hopping frequency is always tracking the transmitter, repeated or multiple packets are received in the same way as any other packet that is transmitted.

Outbound Frame Adaptation:

Once FH code alignment is obtained, the WT receiver can enter the frame adaptation process. This process is that of the WT aligning its 4 ms frame clock so as to permit each timeslot transmitted by the WBSR to be received. The Unique Word 46 transmitted by the WBSR is used as a reference.

If timing is maintained over a period of several frames, the WT receiver has successfully adapted its frame and hop timing to that of the WBSR transmitter. Note that the WT will attempt to time to the first WBSR that is detected.

WT FH Code Tracking:

Once the WT is adapted, authenticated and auto-timed, it will hop through the FH sequence and handle traffic transparently. Loss of single or multiple data bursts can be tolerated without re-initialization of the adaptation and authentication process.

Call Processing Service:

Inbound or Outbound call set-up requests are serviced by the WBS call processing software. The software assigns a pair of air interface timeslots to provide a duplex communications link. Once established this link is used to carry encoded voice traffic. Additional data bits are also transmitted with the encoded voice to provide a low-speed signaling channel for each timeslot. The duplex link is maintained by the call processing software until the call is terminated at either end.

Dynamic Channel Allocation (DCA):

During normal system operation, each active WBSR independently chooses its own hopping sequence. A WBSR that is carrying traffic and has no available timeslots is in All Trunks Busy (ATB) condition. IF a WT is timed to a WBSR that is in ATB and a call attempt is initiated, it must attempt to re-time to another WBSR located in the same WBS cabinet. If indeed there is a second WBSR provisioned within the same WBS cabinet as the WBSR operating in an ATB condition the WT requesting service will switch communication to the second WBSR. Should the second WBSR have a free timeslot pair available it will then assign them to the call initiation request. If all timeslots are busy then the process would be repeated with all the WBSR equipped in the WBS cabinet. If, after completing this search, no timeslots are available, an ATB busy tone will be returned to the subscriber who is attempting to initiate a call. Since the WT can dynamically search for available WBSRs, this feature is known as Dynamic Channel Allocation or DCA. With DCA, a WBS cabinet can offer a larger pool of available trunks, thus increasing the traffic capacity of the system.

Automatic Speed Control:

Once a duplex VF link has been set up, the WBSR monitors the VF traffic for data or fax modem hand-shaking tones. If a valid tone is detected, then the WBSR will change the voice coding to PCM, which is transferred at a rate of 64 kb/sec. If the additional bandwidth required to support a 64 kb/s connection is not available, no further action is taken, and the modem/fax traffic is transported at the original connection rate. The use of ASC does not therefore involve any coordination or adaptation of the hop set. This feature significantly increases the throughput of data communications using dial-up modems.

Multiple WBS Sites:

Co-located communications WBS cabinets used to provide additional capacity can be cabled with a single coaxial cable so that the WBS frame marker can be derived from a master cabinet and passed to the other auxiliary cabinets. This ensures that TDD frames for all such cabinets are aligned.

Remote communications WBS cabinets, that are used to provide fill-in coverage within a service area shall be connected to the same network access point and shall therefore have the same T1 frame clock timing and frequency stability as the WBS located at the main site. This ensures that the 4 ms frames generated at separate WBS cabinets will not drift with respect to one another over time, thus preventing potential interference between the Outbound and Inbound systems.

What is claimed is:

1. A wireless communications system comprising:
a base station having:
a first base station radio for frequency hopping transmission and including a first frequency sequence selector for selecting a first predetermined sequence of frequencies; and
a second base station radio for frequency hopping transmission and including a second frequency sequence selector for independently selecting a second predetermined sequence of frequencies different from the first.

2. A wireless communications system as claimed in claim 1 wherein the first frequency sequence selector includes a plurality of predetermined frequency sequences.

3. A wireless communications system as claimed in claim 1 wherein the second frequency sequence selector includes a plurality of predetermined frequency sequences.

4. A wireless communication system as claimed in claim 3 wherein the plurality of frequency sequences is the same as for the first frequency selector.

5. A wireless communication system as claimed in claim 1 wherein the first base station radio includes a radio interference monitor.

6. A wireless communication system as claimed in claim 5 wherein the frequency sequence selector is responsive to an output from the radio interference monitor indicating that interference is above an acceptable level.

7. A wireless communication system as claimed in claim 1 wherein the second base station radio includes a radio interference monitor.

8. A wireless communication system as claimed in claim 7 wherein the frequency sequence selector is responsive to an output from the radio interference monitor indicating that interference is above an acceptable level.

9. A wireless communication system as claimed in claim 1 wherein the selection of the second frequency sequence is in dependence upon interference with that sequence.

10. A method of operating a wireless communications system comprising the steps of:
at a base station, selecting a first predetermined sequence of frequencies for frequency hopping transmission by a first base station radio; and
independently selecting a second predetermined sequence of frequencies different from the first for frequency hopping transmission by a second base station radio.

11. A method of operating a wireless communication system as claimed in claim 10 wherein the step of selecting the second frequency sequence is in dependence upon interference with that sequence.
